(19) United States
(12) Patent Application Publication
(10) Pub. No.: US 2008/0040156 A1
(43) Pub. Date: Feb. 14, 2008

(54) Computerized system for tracking, managing and analyzing hospital privileges through the use of specifically researched content in conjunction with ICD, CPT or other codes

(76) Inventor: James Cox, Franklin, TN (US)

Correspondence Address: ERIC ROBINSON, PMB 955, 21010 SOUTHBANK ST., POTOMAC FALLS, VA, 20165, US

(21) Appl. No.: 11/890,544

(22) Filed: Aug. 7, 2007

Related U.S. Application Data
(60) Provisional application No. 60/836,138, filed on Aug. 8, 2006.

(51) Int. Cl. G06Q 50/00; G06F 17/30; G06Q 10/00

(52) U.S. Cl. 705/2

(57) ABSTRACT

A computerized system to manage privileges and billing codes individually and in concert. Including tracking, managing and analyzing hospital privileges through the use of specifically researched content in conjunction with ICD, CPT or other codes.

### OVERVIEW

Hospitals are always seeking ways to increase patient safety and reduce risk. There are many systems and policies that have been developed to assist hospitals in accomplishing these goals. One of those policies is generally known as ‘core’ or ‘evidence based’ privileging.

Typically when a doctor or other health professional joins a medical staff, the hospital or other care facility must determine what the doctor will be allowed to do in that facility. For example, you probably wouldn't want an ophthalmologist removing someone's appendix so, that ophthalmologist must be restricted in some way as to the procedures they would be allowed to perform. Also, inherent in some procedures, are issues of education in that specialized procedures may require training beyond minimal levels. Finally, there are several systems of ‘codes’ that are used to describe these procedures for billing purposes that can also affect the extent or even the method of performing a given set of procedures.

Until recently, there was no accepted method of controlling this list of privileges beyond simply granting the privileges that the physician requested. This has become known as the “laundry list” method because the list of the procedures normally gave no details beyond its name. The physician would simply check off the privileges he wanted. This approach naturally assumes that the physician to be self determinant as to his own skill level and training. This policy has led to many situations in which physicians are performing procedures they are not necessarily qualified to do. Further, as some of the lines between specialties begin to blur, as in certain radiology and cardiology procedures for example, large discrepancies can be found between the two specialties in requirements to do exactly the same procedure.

A number of high profile legal cases have brought the weakness in the ‘laundry list’ methodology to the industry's attention. As a result, a new method of privileging physicians and other health care workers was created and has become generally known in the industry as ‘core privileging.’ Core privileging is essentially the process by which a list of privileges by specialty is developed and then further described by the education, special training or other requirements a physician must meet prior to the physician being granted permission to perform that procedure in the health care facility.

Unfortunately, the work necessary to create this information and its subsequent management are quite daunting and have resulted in very few health care facilities being able to implement the process. Further, even facilities with limited success in core privileging are now facing the need to further break down the descriptions of procedures into their associated procedure codes published by such entities as the World Health Organization (WHO) and the American Medical Association for examples (AMA). The effort of private enterprise to assist these health care facilities ha s been at best, superficial and at worst, helping to perpetuate the ‘laundry list’ approach.

The purpose of this invention is to supply health care facilities with a computerized system to create, edit and manage health care worker privileges through the use of highly researched privileging information and coupled with the appropriate codes reflective of that procedure all of which are pre-loaded as part of the system and require no further intervention by the user.

Privileging Requirements

In order to accomplish ‘core’ or ‘evidence based’ privileging, a number of things are needed:
a) Each medical specialty should have it own set of privileges
b) Each privilege within the specialty must:
   a. be well documented and researched through reliable medical sources that are subsequently reviewed by appropriate medical panels
   b. contain a description of the basic education the physician is required to have
   c. describe a list of procedures that can be included in the physicians' basic education
   d. describe a list of ‘special’ procedures that require training or impose other limitations on performing those procedures
   e. for any ‘special’ procedures a specific set of criteria that contains:
      i. the education needed to perform the ‘special’ procedure
      ii. an description of the procedure that is adequate to determine its scope
      iii. the performance level needed to be grant or renew the privilege
      iv. approval from an authorize medical entity within the facility
   f. A date that the privilege was granted and expires
c) Each privilege should be matched to one or more billing codes in order to measure the performance of each privilege.

Although this list of requirements seems straight forward, it is extremely difficult for any hospital to create and implement such a system. The barriers are essentially three fold 1) there is no central source that lists the privileges associated with a specialty 2) once identified, there is no central source in which to research the actually makeup of the privileges 3) billing codes have not been cross referenced to privileges and are often in conflict with privilege descriptions. These problems are compounded by the typical hospitals internal structure, lack of time on the part of physicians to devote to this topic and the strange complexity of billing codes.

Current State of the Art

There have been several attempts by the industry and private enterprise to address the shortfall in privileging. The currently available solutions fall far short of the comprehensive nature of privileging and usually only address one or two of the aspects needed to adequately manage the process. The invention seeks to combine all the necessary elements through a computerized system that allow for the management and distribution with relative ease.

The first big barrier has been the development of the definition of the privilege and their component parts as outlined above. The second major barrier is connecting those privileges to billing codes.

The few privileges that are either in the public domain or offered by companies such as those at www.privileging.com, which was founded by this inventor, are the most complete systems currently offered. However, they do not include the level of privileging detail needed or proposed nor do they include the associated billing codes or their manipulation and management. The privileges currently being offered have not been fully reviewed by a independent, qualified medical panel and hence might be questioned by doctors. Even though they are highly likely to be correct, they lack the credibility needed to quickly establish them as the standard for the industry.

Tying privileges to billing codes to privileges is an entirely different matter. This has not been done in any context either publicly or by private enterprise. This is due to the complexity of billing codes and a lack of a system for managing the codes in ways that they can be related to specific privileges.

Industry organizations and groups have done little in either of the areas in question. The Accreditation Council for Graduate Medical Education (ACGME) which is the body responsible for medical education, has done some work in describing some ‘core’ and ‘special’ procedures and the ‘needs’ of a process have been outlined by Joint Commission on Accreditation of Healthcare Organizations (JCAHO), which is widely recognized as the standards hospitals should follow. However, there is no single source in the industry that offers any help to hospitals in developing or managing evidence based privileging.

Private concerns have been a bit more responsive. Most companies that sell credentialing or quality software have a ‘privileging system’ however, on close examination they are merely a framework in which a hospital can put the privileging information it develops and for the most part, they do not include any detailed information and no company has included a list of corresponding billing codes.

### BRIEF DESCRIPTION OF THE DRAWINGS

FIG. 1 is a representation of an initial master load from Master data with local customization for the present invention.

FIG. 2 is a representation of an Add or Update local user data from Master data for the present invention.

### THE INVENTION

The invention consists of three major sections 1) the privileges and their associated information 2) billing codes listed and assigned to privileges 3) a computerized system to manage privileges and billing codes individually and in concert. Since the lists of privileges and the lists of billing codes are fundamentally copyrightable material, the most important aspect to the invention is the management and manipulation of the privileges and the codes.

The privileges and their associated content have been outlined earlier and for the most part will be covered by the appropriate copyright law. However, it has been demonstrated many times that hospitals do not have the resources to create an encompassing set of privileges. Therefore, it is essential that a complete set of privileges for every specialty be pre-loaded in the system that could then be easily modifiable within the system to fit local norms. Additionally, ongoing support through revision tracking and addition would be necessary. This is especially true for new procedures and cross-over procedures. Most lawsuits require that information about the standard of care be reviewed within the context of time. That is, the standard of care must be that standard that was in force when the incident occurred, not the current standard.

The billing codes are very complex. There are several standards that the industry uses but currently the two most favored are CPT and ICD codes. Both systems have a great deal of overlap in their use but ICD's tend to be used more at the hospital level while CPT codes are used by outpatient facilities. There are thousands of codes and there is an entire industry dedicated to analyzing and using these codes for billing purposes however, to date no one has used them in a privileging setting. The reason for this is that before a code could be tied to a privilege, a solid set of privileges needs to be established. This is compounded by the problem that not every hospital is identical. A privilege that works at one hospital does not necessarily work, or is defined exactly the same, at another. Hence, the associated billing codes also need modification and management to work effectively in the system. As was done for privileges, a complete default set of codes that match the default set of privileges must be pre-loaded for the system to be successful.

To affect the management and manipulation part of the system and to complete any substantial commercial product, the system must accomplish several things:
A) The system must be pre-loaded with a complete, detailed set of privileges, as described earlier, by specialty.
B) The user must be allowed to edit the list of privileges or change the education or other requirements to grant and maintain any or all of the specific privileges.
C) Special privileges, those that require additional training or proctoring, must be housed in such a way as to permit the editing of those requirements.
D) A master library of all privileges must be included to allow a return to previous versions and/or to track version history.
E) Privileges must be assignable to individual health care workers and the content of those privileges needs to be editable on an individual basis.
F) A comprehensive list of ICD, CPT or other codes that are tied to individual privileges needs to be included in the system.
G) The list of included ICD, CPT or other codes must be editable by the user to accommodate local norms or desired tracking
H) The system must track the dates of granted and expiring privileges
I) The system must contain some health care worker demographic data in order to assure easy identification by external personnel.
J) A system that uses standards to allow for information interchange with other computerized systems.

One object of the present invention is to provide a computerized system for tracking, managing and analyzing hospital privileges through the use of specifically researched content in conjunction with ICD, CPT or other codes.

A further object of the present invention is to provide a system that is installed with pre-loaded privileging content that includes details of basic education requirements for a privilege(s). Yet another object is to provide such a system that is installed with pre-loaded privileging content that includes a list of privileges, by specialty, that are normally given to health workers that can demonstrate the basic education requirement. A still further object is to provide such a system that is installed with pre-loaded privileging content that includes special procedures that require training in excess of the basic education or that require conditions such as proctoring or other restrictions. A further object is to provide such a system that is installed with pre-loaded privileging content that includes detailed information called ‘threshold criteria’ that describe the training and conditions of the special privileges.

Another object of the present invention is to provide a system that contains a ‘master’ database of privileges as well as a ‘local’ copy of the privileges that can be modified by the user. A still further object is to provide a system that allows for editing of information in order to adjust the information for local conditions. Yet a further object of the present invention is to provide such a system that is installed with pre-loaded content that includes ICD, CPT or other billing codes that are cross referenced to the privileges.

Another object of the present invention is to provide a system that contains a ‘master’ database of ICD, CPT or other codes as well as a ‘local’ copy of the codes that can be modified by the user.

A further object is to provide a system for manipulating the ICD, CPT or other codes in order to relate or ‘tie’ them to various privileges.

Yet another object is to provide a system that tracks versions and changes in time so that an historical record can be created for either privileges or codes.

A still further object is to provide a system that allows for the external maintenance of privileges and/or billing codes by outside subject matter experts.

Yet a further object of the present invention is to provide a system that can show the differences between the master list of privileges and/or billing codes and any local copy.

Another object is to a system that contains basic healthcare worker demographics in order to facilitate the review of privileges by worker.

A further object is to provide such a system that can interface with various billing systems in order to extract procedure information.

A still further object of the present invention is to provide a system that can control the information displayed by user type or role.

Yet another object of the present invention is to provide a system that can keep track of procedures performed by health care workers in order to analyze worker performance or requirements with respect to privileging.

A further object of the present invention is to provide a system that supports searching for health care workers by privilege or billing codes.

Another object of the present invention is to provide a system that allows for annotations or restrictions to be placed on health care worker privileges.

A still further object of the present invention is to provide a system to allow for viewing health care worker privileges and annotations in the surgical suite of a hospital or other health care facility.

Yet another object of the present invention is to provide a system that tracks the dates privileges were granted and/or expire for health care workers. A further object of the present invention is to provide a system that tracks the expiration of privileges and alerts the user of the impending expirations.

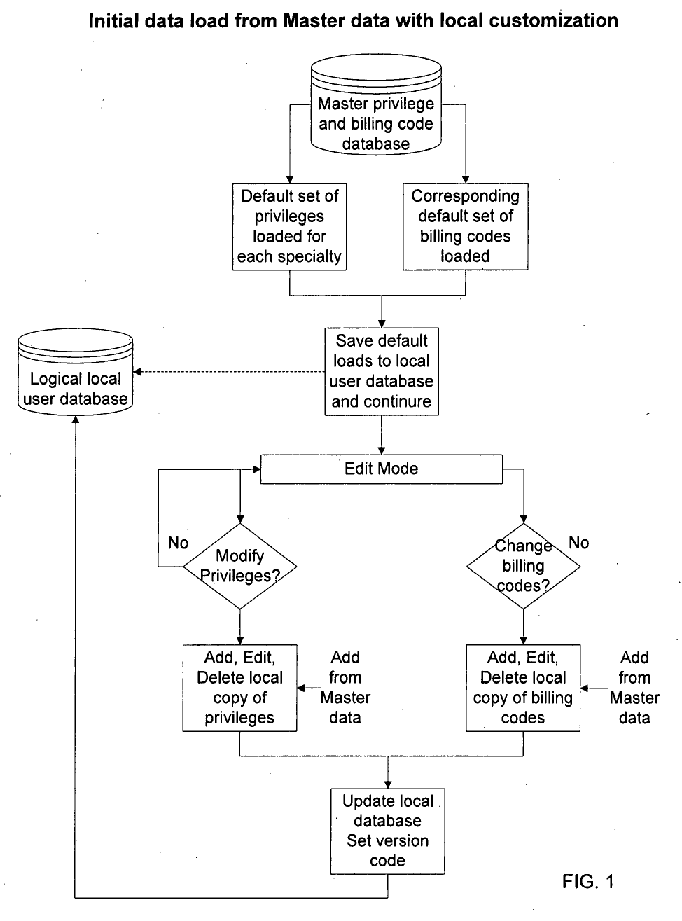

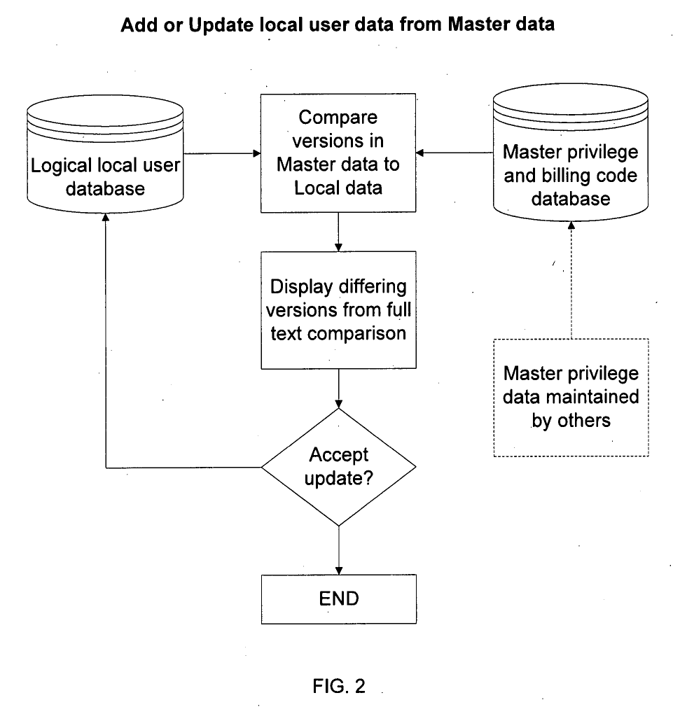

In view of these requirements, FIGS. 1 and 2 depict the logical flow of the system and its general implementation.

What is claimed is:

1. A computerized system for tracking, managing and analyzing hospital privileges through the use of specifically researched content in conjunction with ICD, CPT or other codes.

2. A system that is installed with pre-loaded privileging content that includes details of basic education requirements for a privilege(s).

3. A system that is installed with pre-loaded privileging content that includes a list of privileges, by specialty, that are normally given to health workers that can demonstrate the basic education requirement of claim 2.

4. A system that is installed with pre-loaded privileging content that includes special procedures that require training in excess of the basic education of claim 2 or that require conditions such as proctoring or other restrictions.

5. A system that is installed with pre-loaded privileging content that includes detailed information called ‘threshold criteria’ that describe the training and conditions of the special privileges of claim 4.

6. A system that contains a ‘master’ database of privileges as well as a ‘local’ copy of the privileges that can be modified by the user.
